(19) United States
(12) Patent Application Publication
(10) Pub. No.: US 2003/0174662 A1
(43) Pub. Date: Sep. 18, 2003

(54) Control information signaling method and network element

(76) Inventor: Esa Malkamaki, Espoo (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/344,955

(22) PCT Filed: Sep. 6, 2001
(86) PCT No.: PCT/FI01/00776

(30) Foreign Application Priority Data
Sep. 7, 2000 (FI) 20001975

(51) Int. Cl. H04B 7/00

(52) U.S. Cl. 370/310

(57) ABSTRACT

The invention is directed to a method for transmitting control information such as acknowledgement messages in a cellular telecommunications network. According to the invention, the acknowledgement messages (ACK-PDU) are transmitted more protected by repeating the ACK-PDUs several times and using soft combining. The soft combining mechanism is preferably the same as for actual data. Preferably, the ACK-PDUs are not requested to be re-transmitted but are immediately repeated several times. The inventive method is most advantageous, if the soft combining of transmitted data units (PDUs) is performed on the basis of physical layer information such as physical layer frame numbers, since acknowledgment messages do not normally have a packet number as the data units, which the ACK messages refer to. The inventive method can be used for transmission of other control information as well, and is not limited to transmission of only ACK messages.

### TECHNICAL FIELD OF THE INVENTION

The invention is directed to a method for transmitting control information such as acknowledgement messages in a cellular telecommunications network. Particularly, the invention is directed to such a method as described in the preamble of claim 1.

### BACKGROUND OF THE INVENTION

The present digital cellular telecommunication systems offer in addition to normal speech services also other types of communication services, such as fax transmission and data transmission. New services such as packet data services and live video transmission are presently being introduced at the time of writing of this patent application. Packet-based transmission is suitable for example for transferring data files, browsing the Internet, and other similar uses. Each service has its characteristic combination of properties such as data transfer rate, minimum and maximum delays, error correction methods, and other properties. This application is concerned with error correction mechanisms.

Some data transmission services are so called acknowledged mode data (AMD) services. In AMD services, data transmitted over the air interface from a transmitter to a receiver is acknowledged by the receiver, i.e. the network sends an acknowledgment signal ACK back to a mobile terminal as a response to receiving a data packet from the mobile terminal. AMD services are typically used for connections, which require that the transport medium provides at least some degree of protection against data transmission errors.

Data transmission errors can be corrected in many ways. Different kinds of checksums can be attached to a packet or, more generally, to a data unit such as a RLC PDU (Radio Link Control Protocol Data Unit), which checksums enable the receiver to check if any errors have occurred during transmission. In some cases the checksum enables the receiver also to correct the errors in a received packet, depending on the method used to calculate the checksum and the number and location of the bit errors in the packet. The receiver can also request the transmitter to retransmit a packet by sending an automatic repeat request (ARQ) message to the transmitter as a response to receiving an erroneous packet. In a process called soft combination, the original erroneous packet is not discarded but is combined with the retransmitted packet, and the combined result is used as the received packet.

Error handling schemes which combine the use of automatic repeat request with an error detection and correction mechanism are called hybrid ARQ (HARQ) schemes. Three types of hybrid ARQ schemes have been defined, namely Type I, Type II, and Type III.

The Type I hybrid ARQ is an Adaptive Coding Rate (ACR) method. The main idea behind ACR ARQ methods is to vary the coding rate for error correction according to system constraints such as the signal-to-noise ratio in the given environment. With ACR ARQ, whenever a data RLC-PDU is received with an uncorrectable error pattern, that RLC-PDU is discarded and a request for retransmission is sent back through a return channel to the transmitter. The transmitter then sends the original RLC PDU again.

The type II hybrid ARQ belongs to the Adaptive Incremental Redundancy (AIR) ARQ schemes. In AIR ARQ schemes, a RLC-PDU that needs to be retransmitted is not discarded, but is combined with some incremental redundancy bits provided by the transmitter for subsequent decoding. The advantages of type II hybrid ARQ, relative to type I hybrid ARQ, is that if the interference distribution across the cell is such that a significant fraction of RLC-PDUs will be received correctly even with the low initial code rate then a higher throughput can be achieved. Further, since repeat transmissions can be soft combined there is an increase in the probability of correctly decoding the RLC-PDU.

In Type III hybrid ARQ the retransmitted packed may be combined with the previous versions if available, but each version contains all the information necessary for a correct reception of the data. It does not offer obvious throughput gains relative to type I hybrid ARQ save those that arise from the combining of consecutive transmissions offering a better decoding probability than repeat transmissions with type I hybrid ARQ, which may still be significant.

Soft combining can also be applied with type I hybrid ARQ. This implies that the erroneous packets are not discarded but buffered in the receiver. When a new version of the same packet is received, the packets are combined. This combining can be accomplished in many ways. For instance, the packets can be diversity combined symbol by symbol before decoding using e.g., maximum ratio combining, or the combined packet can be considered as lower rate code which is then decoded.

Type I hybrid ARQ with (soft) combining can be considered as type II/III hybrid ARQ where the ‘incremental redundancy’ is actually the same as the first transmission.

Both the Type II and Type III as well as type I with soft combining requires that a PDU number reference or other information about which packets should be combined is signalled outband in order to have the possibility to associate and soft combine different versions of the packet: the receiver will combine the version of the data that are indicated from the outband signalling to have the same PDU number. In this context the term outband means that another, more reliable, channel is used for the transmission of the information.

There are at least two basic ways of providing the soft combining information to the receiver, i.e. information about which packets should be combined. One way is to base the combining on the RLC PDU sequence number (SN). This requires that the PDU SN has to be coded more strongly, for example by service specific coding or by using a separate transport channel for it. A second way is described for example in patent application PCT/FI00/00307. In that method, the combining is based on the physical location of the first transmission, i.e., for instance, the connection frame number (CFN) as well as the transport block number (TB#) within the frame for the first transmission are transmitted with the retransmissions. The receiver is assumed to buffer the erroneous PDUs with the connection frame number as well as the transport block number.

Type I hybrid ARQ scheme without combining is included in UMTS standard at the time of writing of this application.

All hybrid ARQ schemes using soft or hard combining can tolerate higher frame error rate (FER) values, since the combining provides a powerful enough error correction after a few retransmissions. Simulations have indicated that from the overall system capacity point of view, it would be better to operate at higher FER (i.e., at a lower E_{b}/Nₒ) and thus have more users. However, the high FER is problematic for the control of the ARQ schemes, if the ACK messages are transmitted using the same channel, since the retransmission and soft combining mechanism is used only for payload data, whereby the transmission of ACK messages cannot benefit from soft combining.

Some systems treat this problem by using more protected ACK messages by applying service specific coding. For instance, in the GPRS system (General Packet Radio Service) ACK messages are transmitted using always the most robust link adaptation mode.

When soft combining is used, the acknowledged mode data (AMD) service can be operated at higher FER. Higher FER operating point can give better overall system capacity when more users can be allowed in the system. Also, temporal overloading situations can be easily handled by reducing the power of the AMD service users during the peaks of RT (real time) service users. Typically in a 3rd generation cellular system, more data is supposed to be transferred in the downlink direction. Therefore, it desirable to have more powerful ARQ techniques utilizing soft combining in the downlink. In the uplink, conventional type I hybrid ARQ should be enough. This leads to an asymmetric situation: downlink data traffic with soft combining HARQ can tolerate higher FER and is therefore frequently operated at lower signal to interference ratio (SIR) whereas the uplink data traffic has to be operated at low FER. This setup is suitable for data traffic, but is problematic regarding transmission of ACK messages, especially the ACK messages acknowledging uplink traffic. Those ACK messages are transmitted in the downlink direction, and due to the higher FER can easily be lost in errors. Especially, if the uplink connection is of good quality, the ACK messages can be infrequent, whereby the loss of an ACK message is even more harmful.

The ARQ protocols are typically operated at RLC (radio link control) layer, i.e., between the RLC entity in the mobile terminal and the RLC entity in the network, which is typically located in the radio network controller (RNC). The RLC segments service data units (RLC-SDU), typically the IP packets, into RLC PDUs which are numbered and transmitted via MAC and physical layers to the receiving RLC. The receiving RLC acknowledges the correctly received PDUs and requests retransmissions for the erroneous PDUs using the PDU sequence numbers (SN). The soft combining can then be based either on the RLC PDU SN or the physical location of the first transmission as described earlier.

Recently, a fast hybrid ARQ scheme (as part of a so called high speed downlink packet access (HSDPA) concept) has been proposed. There the retransmissions are typically requested already by the physical layer of the terminal and retransmissions come directly from the base station (from physical layer or, if part of the RLC layer is moved to base station, from the RLC layer). Due to the fast feedback, it is possible to use a so called stop-and-wait (SAW) protocol which simplifies the hybrid ARQ combining since the packets to be combined are always in known positions. In a SAW protocol a new packet is transmitted only after the earlier packet has been correctly received and acknowledged. To alleviate the processing requirements, there can be several parallel SAW processes which are in different phases, i.e. one process can transmit a packet while the other is receiving an acknowledgement. This fast HARQ protocol can also be called a physical layer HARQ if it is operated between physical layers. In addition to this fast HARQ, the existing RLC layer ARQ (not using combining) can be used, too, thus implementing a hierarchical ARQ scheme: soft combining is performed in the lower layer ARQ process between the mobile terminal and the base station and the higher layer (slower) ARQ without combining is between the mobile terminal and the RNC.

A prior art document U.S. Pat. No. 6,021,124 is known to disclose a solution where a network that uses a multichannel ARQ method sequentially multiplexes the data packets at a source and transmits them over corresponding channels. The network applies a stop-and-wait ARQ method on each one of the channels and determines whether the destination has positively acknowledged data packet. If not, the network retransmits only those data packets that were not positively acknowledged.

Another prior art document Braneci M. et al: “Ambiguity analysis for a hybrid type II ARQ/FEC protocol on a fluctuating radio channel”, 1997 IEEE International Conference on Communications, 1997, ICC97, vol. 2, 1997, pages 1068-1072, XP002902142 Montreal is known to propose a hybrid type II ARQ/FEC scheme that uses concatenated coding. To manage the reception of packets with corrupted control, the document introduces an intelligent mechanism.

### SUMMARY OF THE INVENTION

An object of the invention is to realize a method for transmission of control information, which does not suffer from the problems of prior art. A further object of the invention is to realize a method for transmission of control information, which is more robust and error resistant than the methods known in the prior art.

The objects are reached by repeating and soft combining the control information message a sufficient amount of times to ensure a successful reception of the message.

The method according to the invention is characterized by that, which is specified in the characterizing part of the independent method claim. The radio network element according to the invention is characterized by that, which is specified in the characterizing part of the independent claim directed to a radio network element. The dependent claims describe further advantageous embodiments of the invention.

According to the invention, the acknowledgement messages (ACK PDU) or other control information messages are transmitted more protected by repeating the corresponding ACK PDUs several times and using soft combining. The soft combining mechanism is preferably the same as for the actual data. Preferably, the ACK PDUs are not requested to be retransmitted but are immediately repeated several times, if the quality of the transmission channel is not good enough for a reliable transmission of a single instance of an ACK PDU. The inventive method is most advantageous, if the soft combining of transmitted data units (PDUs) is performed on the basis of physical layer information such as physical layer frame numbers, since acknowledgment messages do not normally have a packet (PDU) number similar to the data units, which the ACK messages refer to. The inventive method can be used for transmission of other control information as well, and is not limited to transmission of only ACK messages.

### BRIEF DESCRIPTION OF THE DRAWINGS

The invention is described in more detail in the following with reference to the accompanying drawings, of which

FIG. 1 shows a flow chart of a method according to an advantageous embodiment of the invention,

FIGS. 2a, 2b, and 2c illustrate signalling between a mobile station and a network element according to further advantageous embodiments of the invention, and

FIG. 3 illustrates a radio access network according to an advantageous embodiment of the invention.

Same reference numerals are used for similar entities in the figures.

### DETAILED DESCRIPTION

According to an advantageous embodiment of the invention, the ACK messages are transmitted in the same channel as the payload data PDUs by transmitting more than one copy of the ACK and using the same soft combining mechanism-as for payload data PDUs. When an erroneous packet is received, it is buffered in the soft decision buffer to wait for a retransmission. One may note that the receiver does not know whether the received PDU is a payload data PDU or an ACK PDU, since the faulty PDU and consequently the header within the PDU cannot be decoded. When an ACK PDU is repeated, possibly several times, it can be soft combined with the earlier versions.

In an advantageous embodiment of the invention, the ACK PDUs are numbered to enable combining in the receiver. Such an embodiment is advantageous in such cases, when the soft combining of payload PDU's is based on the PDU SN, i.e., the PDU SN is transmitted outband to enable soft combining. The numbering can be different from the numbering of the data PDUs. The outband information preferably indicates that a given PDU is a control PDU and also specifies its SN. The receiver does not need to acknowledge these control PDUs, but if the PDU is in error, it will be buffered and when a retransmission of the same control PDU is received, it will be combined with the earlier version of the same control PDU. In the present example, the outband info for a data PDU can comprise an indication that the PDU is a data PDU, the serial number of the PDU, and an indication of retransmission version, if incremental redundancy type of HARQ is being employed. According to an advantageous embodiment of the invention, the outband info for the control PDU comprises an indication that the corresponding PDU is a control PDU, and a sequence number of the control PDU. The outband info can also further comprise an indication of retransmission version, in the case that incremental redundancy type of HARQ is being employed. The indication of retransmission version may for example state how many times the PDU has now been retransmitted.

According to another advantageous embodiment of the invention, soft combining of control PDUs is based on the physical layer location of the first transmission. The physical layer location can be described in an UMTS cellular system for example by the CFN and TB# parameters, see e.g. patent application PCT/FI00/00307. Such an embodiment is advantageous in such cases, in which soft combining of data PDU's is based on the physical layer location of the first transmission of a PDU. In such an embodiment the outband info is advantageously similar for both data PDU's and control PDU's, since the outband info can simply indicate which packets to combine regardless of the type of the packet or the SN of the packet. The physical layer location information can advantageously be obtained from the MAC layer, which controls the sending of packets.

Advantageously, the MAC layer keeps track of packets it has sent for example based on the SN of PDUs. Advantageously, the MAC layer also keeps track of the control PDUs. In such an embodiment in which the RLC layer initiates the repetition of control PDU's, the RLC layer advantageously adds an indication in the header of the data packet comprising a repeated control PDU that the PDU is a repeated one, so that the MAC layer is then able to provide the needed outband information of the physical layer location of the corresponding first instance of that particular control PDU.

The number of repeats necessary for decoding the soft combined PDUs depends on the quality of the channel and is advantageously adjusted adaptively. In an advantageous embodiment of the invention, the ACK PDUs are preferably not requested to be retransmitted but they are automatically repeated by the transmitter sufficiently many times to get through.

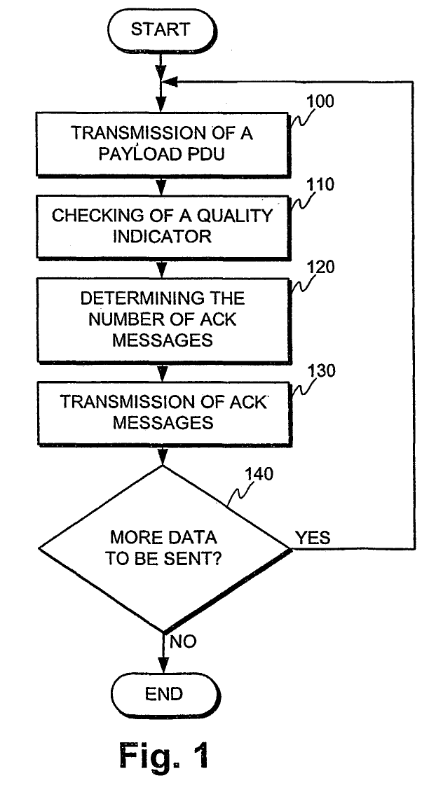

FIG. 1 illustrates a method according to an advantageous embodiment of the invention. In the method, a first communication party transmits 100 a payload data unit, which is received by a second communication party. The second communication party observes that it should send an acknowledgement message as a response to receiving the PDU. Consequently, the second communication party checks 110 the value of a quality indicator. The quality indicator may represent in the case of the second communication party being a network element and the first communication party being a mobile station for example the frame error rate in the downlink direction, the signal to interference ratio (SIR) of the downlink channel as observed by the receiving mobile station, or any other suitable measure of channel quality. Based on the value of the quality indicator, the second communication party determines 120 the number of transmissions of an acknowledgement message, which number guarantees with a sufficient probability the correct reception of the message. At the next step, the second communication party transmits 130 the determined number of acknowledgement messages. In step 140, if there are more data to be sent by the first party, the method is continued at step 100, otherwise the method is ended.

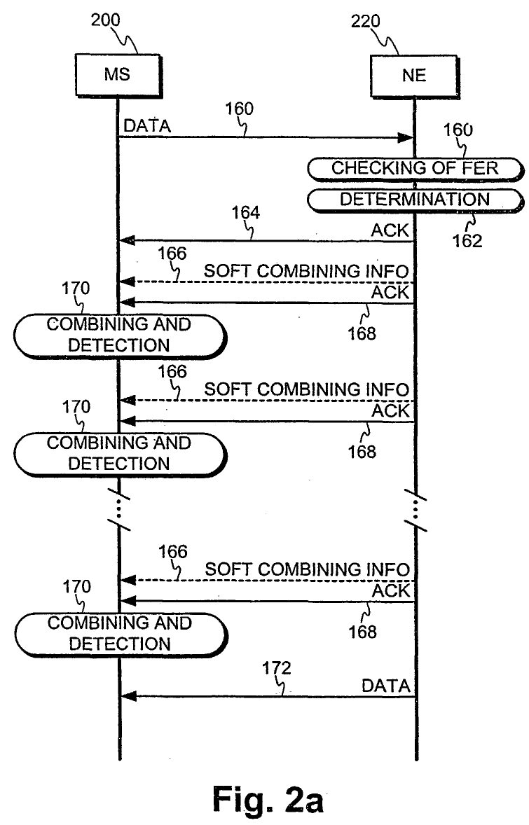

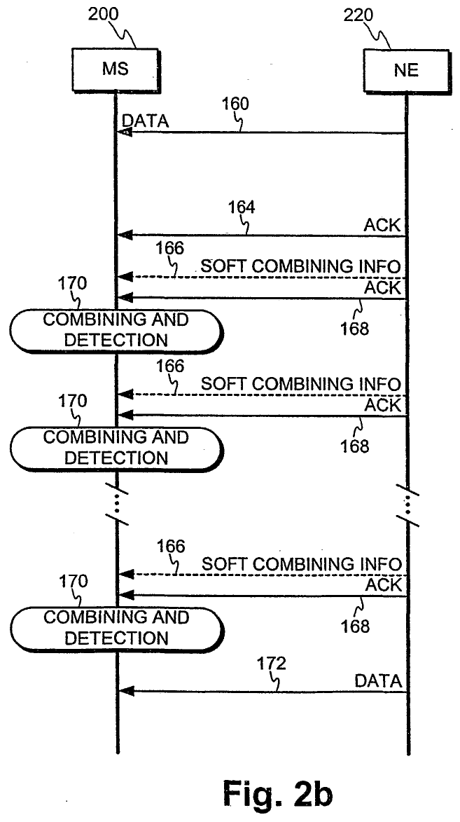

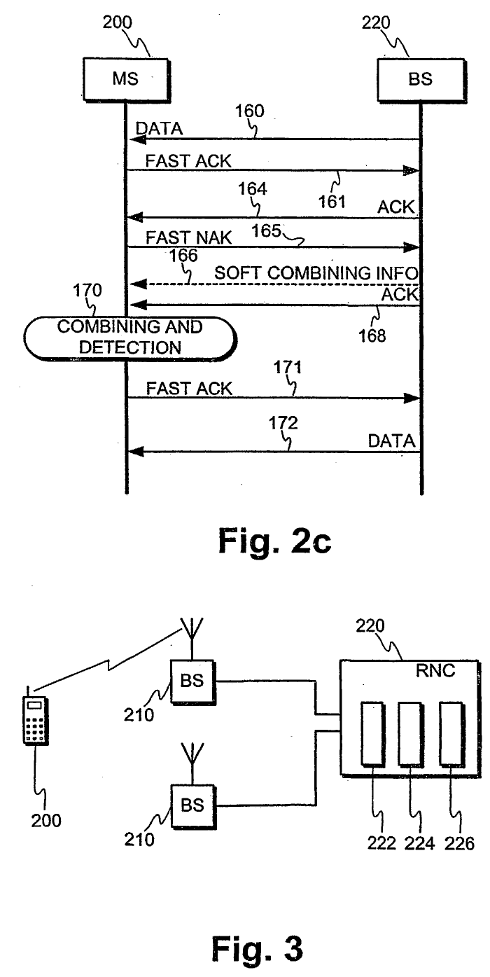

FIG. 2a illustrates signalling between a mobile station 200 and a network element 220 of a cellular telecommunication network according to a further advantageous embodiment of the invention. In step 160, the mobile station sends a PDU to the network element. After receiving of the PDU, the network element checks 160 the quality of the downlink connection by checking the value of a quality indicator such as the FER reported by the mobile station, and determines 162 at least partly based on the value of the quality indicator the number of transmissions necessary for transmitting the control information message with sufficient reliability. The network operator can advantageously determine what constitutes a sufficient reliability for example by specifying a lower limit for the probability of a succesful transmission. In the determination step 162, the network element may then calculate, how many transmissions are enough to raise the probability of a succesful transmission over the specified limit. In the next step 164, the network element sends the control information, in this case an acknowledgement message ACK to the mobile station. In the example of FIG. 2 it is assumed, that the ACK message needs to be retransmitted a number of times to ensure a succesful transmission. Consequently, the network element sends 166 an information message SOFT COMBINING INFO on a separate channel (depicted using a dashed arrow 166) used for transmission of soft combining control information describing that the next PDU is to be combined with the previous PDU, and sends 168 the PDU containing the ACK message again. The mobile station combines 170 the received PDUs and attempts to detect the data in the combined PDU. In this example, the detection is most likely to fail at this step, since multiple repeats are necessary. The steps 166, 168, and 170 are repeated the number of times determined in step 162. Finally, after repeating the ACK message the determined number of times, the mobile station will most probably be able to detect the data in the received and combined PDUs. After this, the signalling may continue normally, and the network element may for example send 172 a downlink PDU to the mobile station.

FIG. 2b illustrates signalling between a mobile station 200 and a network element 220 of a cellular telecommunication network according to a further advantageous embodiment of the invention. In step 160, the network element sends a PDU to the mobile station. In the next step 164, the network element sends the control information, in this case an acknowledgement message ACK to the mobile station. In the example of FIG. 2b it is assumed, that the ACK message needs to be retransmitted a predefined number of times to ensure a succesful transmission. Consequently, the network element sends 166 an information message SOFT COMBINING INFO on a separate channel (depicted using a dashed arrow 166) used for transmission of soft combining control information describing that the next PDU is to be combined with the previous PDU, and sends 168 the PDU containing the ACK message again. The mobile station combines 170 the received PDUs and attempts to detect the data in the combined PDU. In this example, the detection is most likely to fail at this step, since multiple repeats are necessary. The steps 166, 168, and 170 are repeated the predefined number of times determined by the higher layers of the network element. Finally, after repeating the ACK message the determined number of times, the mobile station will most probably be able to detect the data in the received and combined PDUs. After this, the signalling may continue normally, and the network element may for example send 172 a downlink PDU to the mobile station.

The network element 220 may advantageously be a radio network controller. In a further advantageous embodiment of the invention, the network element 220 can be a base station.

When fast i.e. physical layer HARQ is used, the control PDUs can advantageously be transmitted using the same physical or other lower layer retransmission protocol. Since the feedback in this case is fast, even the control PDUs can be requested to be retransmitted. The physical layer HARQ protocol need not even know that whether a PDU is a data PDU or a control PDU, the same procedure can be applied to both. However, it might be useful to limit the number of retransmissions for the control PDUs because the status to be reported in the control PDU may change quite fast.

This can be implemented easily by telling for each PDU (data or control) the maximum number of retransmissions. In this case, mixing data and control PDUs in the same channel is not a problem since the lower (physical) layer HARQ protocol can guarantee the desired level of performance by repeating and combining the packets sufficient amount of times.

FIG. 2c illustrates the physical layer HARQ case. Now the signalling is between a network element, in this case a base station 220 (Node B) and mobile station 200. The control PDUs are repeated when requested by the MS by sending a FAST NAK message. In step 160, the network element sends a PDU to the mobile station, whose physical layer entities return 161 a FAST ACK message. In the next step 164, the network element sends the control information, in this case an acknowledgement message ACK to the mobile station. In the example of FIG. 2b it is assumed, that the ACK message sent in step 164 is not received correctly. Consequently, the physical layer entities of the mobile station return 165 a FAST NAK (negative acknowledgement) to inform the network element that the PDU was not received correctly. Consequently, the network element sends 166 an information message SOFT COMBINING INFO on a separate channel (depicted using a dashed arrow 166) used for transmission of soft combining control information describing that the next PDU is to be combined with the previous PDU, and sends 168 the PDU containing the ACK message again. The mobile station combines 170 the received PDUs and attempts to detect the data in the combined PDU. In this example, the mobile station is able to detect the two combined PDUs, and returns 171 a FAST ACK message to inform that the reception has succeeded. After this, the signalling may continue normally, and the network element may for example send 172 a downlink PDU to the mobile station.

FIGS. 2a, 2b and 2c are an examples only, and the invention is not limited to the use of any specific soft combination method. For example, the mobile station can wait until all transmissions of the same message are received before combining the PDUs and attempting detection of the data.

FIG. 3 illustrates a radio access network of a cellular telecommunications network according to an advantageous embodiment of the invention. FIG. 3 shows a mobile station 200, two base stations 210, and a network element 220 controlling the base stations. The mobile station 200 is illustrated to have a connection to the cellular network via one of the base stations 210. For implementation of the previously described inventive method, the network element comprises means 222 for transmitting a control information message via a communication channel, means 224 for outputting of a value representing the quality of said communication channel, and means 226 for determining the number of transmissions of a control information message at least partly based on the output value of said means for outputting of a value. The network element 220 is advantageously a radio network controller (RNC), especially in the case that the cellular telecommunications network is the UMTS (Universal Mobile Telecommunication System) network.

Preferably the means 222, 224, and 226 for receiving information for construction of a priority order and the selecting means are realized using software programs stored in a memory element of the network element 220 and executed by a processor unit of the network element 220.

The invention has several advantages. For example, the invention makes it possible to operate hybrid ARQ schemes with soft combining at higher FER and lower SIR than according to the prior art, thereby allowing more users in a cell. Also, the control of the system will be more flexible since larger variations in the FER of data channel can be tolerated.

One further advantageous solution for transmitting control information such as ACK messages in a more secure way is to use a different channel for transmitting the ACK messages. This solution is especially suitable for downlink shared channel (DSCH): the payload data PDUs are sent on DSCH and the ACK-PDUs on an associated dedicated channel (DCH). In the case of hybrid ARQ with soft combining, a separate DCH already exists for soft combining control. This DCH can advantageously be used for transmission of ACK-PDUs, whereby using a separate DCH for ACK messages is especially beneficial when hybrid ARQ schemes with soft combining are used. In such a case, the the FER of a single transmission can be quite high, since soft combining guarantees that packets are received with a reasonable number of retransmissions. The high FER is not desirable for transmission of ACK-PDUs, if the same DCH is used for ACK messages. However, if ACK messages are transmitted on a different DCH, the FER of both payload data PDUs and ACK-PDUs can be independently selected to produce the optimum transmission result. Control signalling method according to this solution does not necessarily need to be used in both uplink and downlink directions, For example, in the typical situation that a lower FER is used in the uplink direction than in the DSCH, both payload PDUs and ACK PDUs can be transmitted in the same channel. The use of a separate channel for transmitting the ACK PDUs has the advantage that the ACK PDUs, which are not repeated and therefore will not be soft combined, need not be buffered in the soft decision buffer in the receiver since they can be separated from the data PDUs.

According to a further aspect of the invention, a method for transmission of data in a cellular telecommunication system is provided, in which control information data units are transmitted for controlling of transmission of payload data units, and in which method a payload data unit is sent more than once in certain conditions and in which the received instances of the payload data unit are combined according to a certain method for reducing the effect of transmission errors. According to an advantageous embodiment of the invention, the method comprises the steps of

transmitting a control information data unit at least twice,

receiving said control information data unit at least twice,

combining the received instances of said control information data unit.

According to a further advantageous embodiment of the invention, in said step of combining the received instances of said control information data unit, said certain method is used for performing said step of combining.

The repeating of the transmission of control information data units can in different embodiments of the invention be performed at different communication layers, such as the RLC layer or the physical transmission layer.

According to a further advantageous embodiment of the invention, in which embodiment the control of transmission of a payload data unit more than once is performed by the radio link control layer, the radio link control entity performing said step of transmitting a control information data unit at least twice decides the number of transmissions of a control information data unit.

According to a further advantageous embodiment of the invention, in which embodiment the control of transmission of a payload data unit more than once is performed by the physical transmission layer, a physical transmission layer entity performing said step of receiving sends a repeat request to a physical transmission layer entity performing said step of transmitting.

According to a further advantageous embodiment of the invention, in which embodiment information about retransmission of payload data units is transmitted via another communication channel than the payload data units themselves, information about retransmission of control information data units is transmitted via said another communication channel, and said information about retransmission of control information data units comprises at least an indication that a certain retransmitted data unit is a control information data unit, and a serial number of said certain retransmitted control data unit.

According to a further advantageous embodiment of the invention, said information about retransmission of control information data units further comprises at least the number of times said control data unit has been retransmitted.

According to a further advantageous embodiment of the invention, in which embodiment information about retransmission of payload data units is transmitted via another communication channel than the payload data units themselves, information about retransmission of control information data units is transmitted via said another communication channel, and said information about retransmission of control information data units comprises information describing the physical layer location of the first transmission of a retransmitted control information data unit.

According to a further advantageous embodiment of the invention, the number of transmissions of a control information data unit is determined at least partly based on a connection quality indicator.

Advantageously, the indicator can be for example a frame error rate indicator.

According to a further advantageous embodiment of the invention, the party performing said step of transmitting is a network element of a cellular telecommunication network and the party performing said step of receiving is a mobile station. Advantageously, said network element is a radio network controller (RNC) of an UMTS network. In a further advantageous embodiment of the invention said network element is a base station.

According to a further advantageous embodiment of the invention, the control information data unit comprises an acknowledgement message.

The invention can be used for example in a third generation cellular system such as the UMTS or the IMT2000 system, in both FDD (frequency division duplex) and TDD (time division duplex) mode. The invention is especially suitable for use in a WCDMA (Wideband CDMA) system applying downlink shared channel associated with a DCH and hybrid ARQ with soft combining.

The name of a given functional entity, such as the radio network controller, is often different in the context of different cellular telecommunication systems. For example, in the GSM system the functional entity corresponding to a radio network controller (RNC) is the base station controller (BSC). Therefore, the term radio network controller in the claims is intended to cover all corresponding functional entities regardless of the term used for the entity in the particular cellular tele-communication system. Further, the various, message names such as the SOFT COMBINING INFO message name are intended to be examples only, and the invention is not limited to using the message names recited in this specification.

In view of the foregoing description it will be evident to a person skilled in the art that various modifications may be made within the scope of the invention. While a preferred embodiment of the invention has been described in detail, it should be apparent that many modifications and variations thereto are possible, all of which fall within the scope of the invention.

1. Method for transmission of data in a cellular telecommunication system, in which control information data units are transmitted (130, 164, 168) in one direction for controlling of transmission of payload data units (100, 160) in another direction, and in which method a payload data unit is sent more than once in certain conditions and in which the received instances of the payload data unit are combined according to a certain method for reducing the effect of transmission errors, characterized in that the method comprises the steps of
transmitting a control information data unit at least twice (130, 164, 168),
receiving said control information data unit at least twice (130, 164, 168),
combining (170) the received instances of said control information data unit.

2. A method according to claim 1, characterized in that in said step of combining (170) the received instances of said control information data unit, said certain method is used for performing said step of combining.

3. A method according to claim 1, in which method the control of transmission of a payload data unit more than once is performed by the radio link control layer, characterized in that the radio link control entity performing said step of transmitting a control information data unit at least twice (130, 164, 168) decides (120) the number of transmissions of a control information data unit.

4. A method according to claim 1, in which method the control of transmission of a payload data unit more than once is performed by the physical transmission layer, characterized in that a physical transmission layer entity performing said step of receiving sends a repeat request (165) to a physical transmission layer entity performing said step of transmitting.

5. A method according to claim 1, in which method information about retransmission of payload data units is transmitted (166) via another communication channel than the payload data units themselves, characterized in that
information about retransmission of control information data units is transmitted (166) via said another communication channel,
and said information about retransmission of control information data units comprises at least an indication that a certain retransmitted data unit is a control information data unit, and a serial number of said certain retransmitted control data unit.

6. A method according to claim 1, characterized in that said information about retransmission of control information data units further comprises at least the number of times said control data unit has been retransmitted.

7. A method according to claim 1, in which method information about retransmission of payload data units is transmitted via another communication channel than the payload data units themselves, characterized in that
information about retransmission of control information data units is transmitted (166) via said another communication channel,
and said information about retransmission of control information data units comprises information describing the physical layer location of the first transmission of a retransmitted control information data unit.

8. A method according to claim 1, characterized in that in the method, the number of transmissions of a control information data unit (130, 164, 168) is determined at least partly based on a connection quality indicator.

9. A method according to claim 8, characterized in that said indicator is a frame error rate indicator.

10. A method according to claim 1, characterized in that the party performing said step of transmitting is a network element (220) of a cellular telecommunication network and the party performing said step of receiving is a mobile station (200).

11. A method according to claim 10, characterized in that said network element is a radio network controller (220).

12. A method according to claim 10, characterized in that said network element is a base station (210).

13. A method according to claim 1, characterized in that the control information data unit comprises an acknowledgement message.

14. A radio network element (220) of a cellular telecommunication system, characterized in that the radio network element comprises
means (222) for responding to the reception of a payload data unit by transmitting a control information message via a communication channel,
means (224) for outputting ea quality indicator value representing the quality of said communication channel as observed and previously announced by a second communicating party, and
means (226) for determining the number of transmissions of a control information message at least partly based on the output value of said means for outputting of a quality indicator value.

15. A radio network element according to claim 14, characterized in that it is a radio network controller (220).

16. A radio network element according to claim 14, characterized in that it is a base station (210).
